(19) United States
(12) Patent Application Publication
(10) Pub. No.: US 2008/0262868 A1
(43) Pub. Date: Oct. 23, 2008

(54) Process for gathering and sharing personal medical data

(76) Inventor: Adam Malolepszy, Sudbury (CA)

Correspondence Address: DEVIAT-MIKE M. GAUTHIER, BOX 400, 355 GOODWILL DRIVE, GARSON, P3L 1S7, CA

(21) Appl. No.: 11/785,267

(22) Filed: Apr. 17, 2007

(51) Int. Cl. G06Q 10/00; G06Q 50/00

(52) U.S. Cl. 705/2

(57) ABSTRACT

A process designed to gather and make efficient use of personal medical data wherein all facets of healthcare are now able to share a common database system. The database system is divided into three individual databases where the varied users would have limited user-appropriate access to one or more databases so as to make their function possible. A swipe card system and online access are the key to database entry. Limitations are placed as to what data is inputted and retrieved from the databases.

### FIELD OF THE INVENTION

The present invention relates to a process designed to gather and make efficient use of personal medical data wherein all facets of healthcare are now able to share a common database system. The database system is divided into three individual databases where the varied users would have limited user-appropriate access to one or more databases so as to make their function possible. A swipe card system and online access are the key to database entry. Limitations are placed as to what data is inputted and retrieved from the databases.

### BACKGROUND OF THE INVENTION

In a time where technology offers much of all the world's transactional needs, the paper burden has long been sought to be reduced, even eliminated all together. Healthcare is still today one of the largest producers of paperwork for record keeping.

Technology is sufficiently advanced and tested now that must can agree that security features from hackers and the like can be made a thing of the past through the use of encryptions and other methods.

Through the use of such technologies, the applicant sought to further push the envelope in which software can take a further position in the healthcare industry in a secure process that can now be made useful to all participants in the healthcare system. What was achieved was a process that allows physicians, pharmacists, paramedics, hospitals, drug manufacturers, dentist, optometrists, and all other related entities within the scope of a healthcare system, even the medical insurance administrator.

The applicant is aware of attempts in prior art to provide means of gathering and sharing medical data for the purpose of reducing paperwork and streamlining processes between users.

An example may be had by referring to prior art U.S. Pat. No. 6,117,073 of Jones et al., issued Sep. 12, 2000 depicting an integrated medical database for the emergency medical transportation business wherein the system includes a dispatch module, clinical module, administration module and a billing module. Each module may communicate data with one or more of the other modules to form a system incorporating data sharing, thus achieving an end-to-end automation of emergency medical care accounting.

The above prior art is limited to that of the emergency transportation business and fails to provide data assembly of all facets of the healthcare industry.

Another example of prior art may be had in referring to U.S. Pat. No. 7,039,628 of Logan, issued May 2, 2006, which depicts a portable heath care records system, which employs a server on which the health care records of participating patients are stored. The patients are issued cards that are inserted into the patient's computer to access each patient's records via the Internet for review and editing. The patient record is protected by means of a patient ID and access password. Treating physicians have access to each patient's records for review and update. A firewall permits patients to review their own health records only, but permits the physician to review both the physician files and the patient files. A read-only emergency screen containing important medical data about the patient and may be accessed without the patient's password. Records of many patients and of many clinics are maintained on a common server, so that the patient record can be accessed globally.

However, the above prior art fails in many facets of the present invention in that reminders are not available to the patient, pharmaceutical information is not included nor managed and a user is limited to online password access.

While many attempts in prior art have been made to gather and share medical information with some of the many facets of a healthcare system, none have fully covered all facets of such system to provide a single data system accessible—within limits—to all users in their respective facet.

### SUMMARY OF THE INVENTION

It is thus the object of the present invention to provide a system and process that allows physicians, pharmacists, paramedics, hospitals, drug manufacturers, dentist, optometrists, and all other related entities within the scope of a healthcare system, even the medical insurance administrator, to access and store all respective information of a patient in a single data system.

In one aspect of the invention, access is gained by way of either online login with password, or patient access card and PIN number.

In another aspect of the invention, a computer chip may be imbedded into the patient's person so as to enable care personnel to gain access to patient's limited information in an emergency situation where the patient is unable to identify him/herself.

Accordingly, the system of the present invention provides a system and process that allows physicians, pharmacists, paramedics, hospitals, drug manufacturers, dentist, optometrists, and all other related entities within the scope of a healthcare system, even the medical insurance administrator, to access and store all respective information of a patient in a single data system.

While the invention is embodied within the scope of the healthcare industry, the utility of the invention includes but is not limited to healthcare.

### BRIEF DESCRIPTION OF THE DRAWINGS

These and other advantages of the invention will become apparent upon reading the following detailed description and upon referring to the drawings in which:—

FIG. 1 is a flow chart depicting the division of the database system of the present invention.

FIG. 2 is a flow chart depicting the patient registration process into the database system of the present invention.

FIG. 3 is a flow chart depicting the parameters and flow of data with relation to prescriptions within the use of the present invention.

FIG. 4 is a flow chart depicting the inbound and outbound access to data of the database system of the present invention.

While the invention will be described in conjunction with illustrated embodiments, it will be understood that it is not intended to limit the invention to such embodiments. On the contrary, it is intended to cover all alternatives, modifications and equivalents as may be included within the spirit and scope of the invention as defined by the appended claims.

### DETAILED DESCRIPTION OF THE PREFERRED EMBODIMENT

In the following description, similar features in the drawings have been given similar reference numerals.

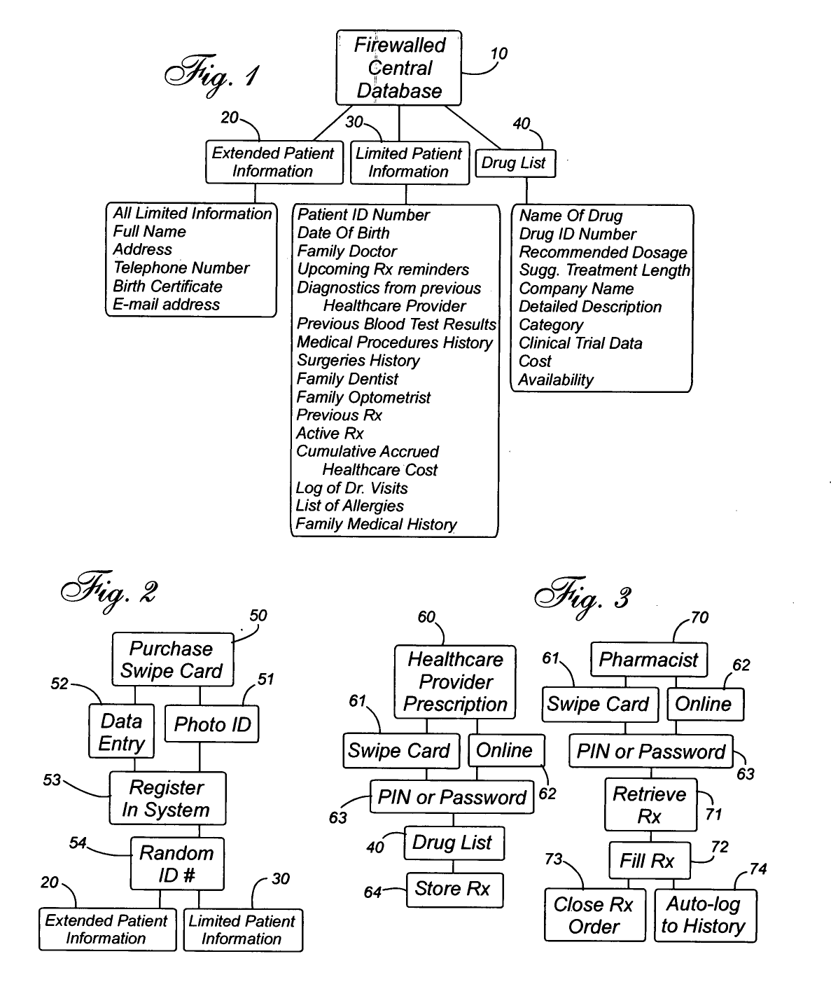

Turning to the drawings, in particular, FIG. 1, a flow chart depicting the division of the database system of the present invention wherein a firewalled central database 10 is partitioned in three primary clusters, namely;
A drug list 40 comprising: name of drug, drug ID number, recommended dosage, suggested treatment length, company or manufacturer's name and information, detailed description of the drug, drug category, clinical test data, cost, and availability,
Limited patient information 30 comprising: patient ID number, date of birth, family doctor, upcoming Rx reminders, diagnostics from previous healthcare provider, previous blood test results, medical procedures history, surgeries history, family dentist, family optometrist, previous Rx, active Rx, cumulative accrued healthcare cost, log of doctor visits, list of allergies and family medical history, and
Extended patient information 20 comprising: all limited patient information per above, full name, address, telephone number, birth certificate, and email address.

The extended patient information cluster 30 of the database 10 will never be accessible by those outside the system administration.

Turning now to FIG. 2, a flow chart depicting the patient registration process into the database system of the present invention wherein registerable swipe cards 50 will be available for purchase by patient from various healthcare related providers. A data entry 52 component will gather required information and save said information into the respective extended 20 or limited database 30 clusters. As a fraud-prevention means, the swipe card will then be processed to include photo ID 51 as well as the patient's name and signature.

Upon registration 53 of the swipe card 50, the administrator will generate a random ID number 54 in place of the patient's name for the purpose of the limited info 30 database's records, effectively limitedly identifying each patient as an ID number. Therefore, even if the database is hacked, no personal information would be divulged, since the only database cluster accessible from outside source is the limited patient information 30 thus preventing any potential risk of identifying the patient for the purpose of fraud. All personal information such as: full name, birth certificate, home address, etc, would be stored on a separate database cluster—namely the extended patient information 20 database—that is only accessible from within the system administration. The administration will have permission to access this extended patient information 20 internally for functions such as: card replacement, change of personal information, and the like. All database information will be set for automatic backups on an hourly basis in order to maintain accurate updated information.

Pharmaceutical companies will find it beneficial to upload their product and drug information to the drug list database. Healthcare providers will then reference this drug list when prescriptions are sought.

Health care institutions such as Clinics, Hospitals, and Doctors, or the like will acquire a swipe card and reader and/or install computer software in order to be connected to the system. When a patient requires medication, the doctor will input his pin giving him access to both the limited patient information and drug list databases.

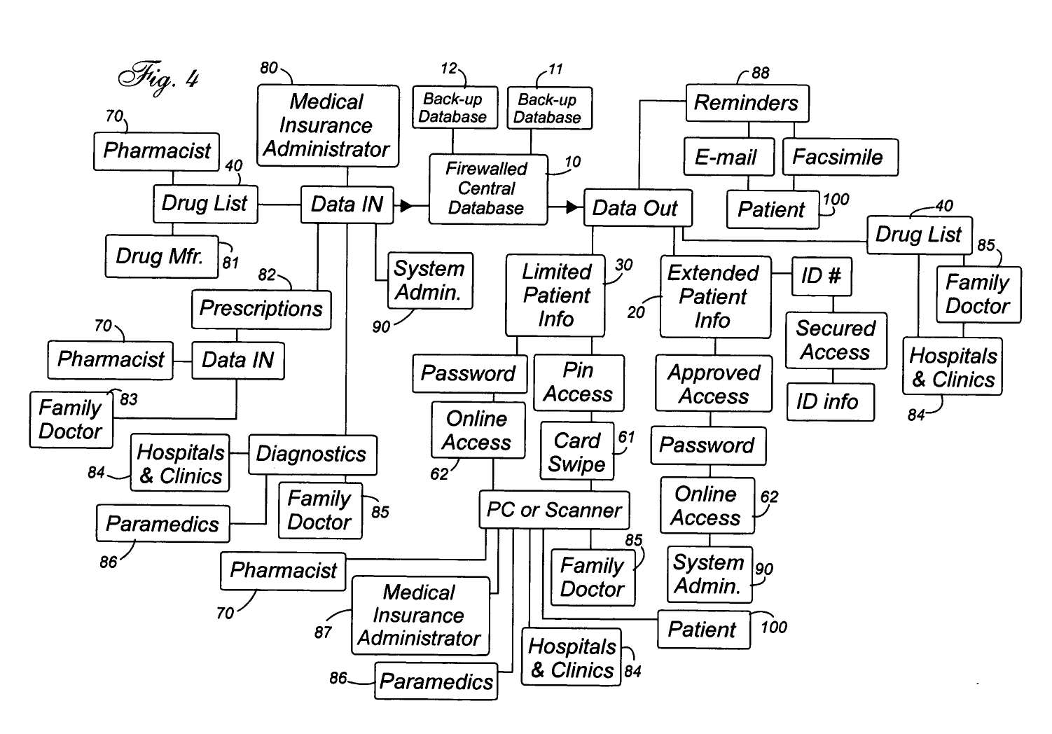

FIGS. 3 and 4, a flow chart depicting the parameters and flow of data with relation to prescriptions within the use of the present invention wherein, for examples, a patient visits a medical clinic, and upon seeing the staff doctor, the swipe card 61 is swiped and the PIN entered 63 to gain access to the limited database, or the doctor may access the online version 62 and enter his/her password 63, the doctor can now view important information such as current prescriptions, warnings, allergies about the patient so as to prevent prescribing medications that may conflict with drugs currently being taken, or allergies the patient may have, or health reasons the patient should not take a specific type of drug. If by chance, the doctor attempts to enter a prescription for a conflicting drug, the system would reject the action and perhaps make a similar recommendation in it's place, which said recommendation would require the doctor's approval prior to acceptance by the system. Upon entry of the prescription into the limited database, system access can now be closed for this session.

The patient then finds his/her way to a pharmacy where the pharmacist 70 would swipe 61, or access online 62 to retrieve any prescription 71 on file. The pharmacist 70 will then proceed to enter crucial information such as dosage, length of prescription, and the like. Once the prescription is filled 72, the pharmacist 70 would then save the entry into patient history and close the session 73. Medical institutions will have access to this information anytime the card is swiped 61 on their system.

In the even of server failure, two or more intercommunicating servers—containing all three database-clusters—20, 30 and 40 will be maintained in real time at various locations, making this system always accessible. This will ensure a continuous uninterrupted state of performance.

The benefits of using the method and process of the present invention are as follows:

Pharmaceutical companies—in order to have their drugs prescribed—will be more than happy to submit their product information 40 as this will serve as a marketing tool. Doctors upon filling-out prescriptions will repeatedly reference the medications listed on the database 40.

Doctors will reduces their risk of errors since the drug interface can flag a doctor if medications prescribed are in conflict with other medications currently prescribed, dosage errors in comparison with patient's medical history, access to all of patient's medical history, larger choice of medications for specific remedies, easy to use computer software, every doctor is assigned a PIN and fills out prescriptions online, and notes can also be added to a patients file.

Pharmacies can ensure that prescriptions are valid, decrease prescription fraud, have the ability to fill prescriptions regardless of location, have patient medical history available at all times, reduces risk of error, and have real time status of medications being prescribed and consumed.

Patients can be prescribed more effective alternatives in medication since the doctor will now be familiar with these alternative, a healthcare provider will have immediate access to all the patients' pertinent medical history from any online connection upon access regardless of location, patients can access their drug manager file and verify prescription information, dosages, reminders, refills etc and be better informed about their present and past health status.

Lastly, insurance companies and government-funded healthcare systems will eliminate abuse of the healthcare system such as fraudulent prescriptions and non-existent doctor visits. Health insurance or government could access the limited patient info database for statistical and cost purposes. Payout to pharmacy

Card swipe systems will be sold to participating institutions and a monthly system-maintenance fee will also apply.

Cards will be sold at a minimal fee to patients on an annual basis (ie. 1, 2, 3 years) and renewed thereafter.

The embodiments of the invention in which an exclusive property or privilege is claimed are defined as follows:

1. A process for gathering and sharing personal medical data comprising:
a. a master database,
b. a second backup database,
c. a third backup database,
d. a data input process,
e. a data retrieval process,
f. a user login system,
g. a smart drug-interface,
h. a drug manager, and
i. a system administrator.

2. The process for gathering and sharing personal medical data of claim 1 wherein the master database is divided into three datasets comprising:
a. limited patient information,
b. extended patient information, and
c. a drug list.

3. The process for gathering and sharing personal medical data of claim 1 wherein the second backup database is a remotely stored editable image of the master database.

4. The process for gathering and sharing personal medical data of claim 1 wherein the third backup database is a remotely stored editable image of the master database.

5. The process for gathering and sharing personal medical data of claim 1 wherein the data input process is limited to users having been granted permission to input data within the master database.

6. The process for gathering and sharing personal medical data of claim 1 wherein the data retrieval process is limited to users having been granted permission to retrieve data from the master database.

7. The process for gathering and sharing personal medical data of claim 1 wherein users can access the master database by obtaining permission from the system administrator.

8. The process for gathering and sharing personal medical data of claim 1 or 7 wherein permission is granted only to those users having a related interest in the healthcare system.

9. The process for gathering and sharing personal medical data of claim 1 wherein each patient is automatically assigned a numerical identification number wherein the patient's personal information is stored in the extended patient information dataset, and is not accessible by related users.

10. The process for gathering and sharing personal medical data of claim 1 wherein the smart drug-interface dataset comprises: drug information, drug conflicts, and dosages, provided by the pharmaceutical manufacturers.

11. The process for gathering and sharing personal medical data of claim 1 or 10 wherein conflicting drugs are automatically flagged when such conflicting drugs are prescribed by care providers for simultaneous use by patient.

12. The process for gathering and sharing personal medical data of claim 1 wherein any access-permitted user can activate a reminder system directed to the patient by way of e-mail or facsimile.

13. The process for gathering and sharing personal medical data of claim 1 further comprising a swipe card granted to each registered patient wherein said card contains limited patient information accessible by patient and family doctor and emergency care providers.

14. The process for gathering and sharing personal medical data of claim 1 wherein a memory chip is imbedded into the patient's person so as to enable care personnel to gain access to patient's limited information in an emergency situation where the patient is unable to identify him/herself.

15. The process for gathering and sharing personal medical data of claim 12 wherein the reminders include:
1. drug intake,
2. prescription refills,
3. appointment with care providers,

16. The process for gathering and sharing personal medical data of either claim 1 through 15 wherein the utility of the process of the present invention allows physicians, pharmacists, paramedics, hospitals, drug manufacturers, dentist, optometrists, medical insurance administrator, and all other related entities within the scope of a healthcare system, to access and store all respective information of a patient in a single data system.
